(19) United States
(12) Patent Application Publication
(10) Pub. No.: US 2026/0300663 A1
(43) Pub. Date: Oct. 1, 2026

(54) PRINTING MANAGEMENT DEVICE AND PRINTING SYSTEM

(71) Applicant: SEIKO EPSON CORPORATION, TOKYO (JP)

(72) Inventors: Takuto TANAKA, SHIOJIRI-SHI (JP); Yusuke KOMIYAMA, MATSUMOTO-SHI (JP); Ayako TANABE, MATSUMOTO-SHI (JP); Asuka SUGIHARA, SHIOJIRI-SHI (JP); Tetsuji YATSUNAMI, OKAYA-SHI (JP); Yuji MISAWA, MATSUMOTO-SHI (JP); Masaki SHIMOMURA, Matsumoto-shi (JP); Kazuhisa KAWAKAMI, MATSUMOTO-SHI (JP)

(21) Appl. No.: 19/636,057

(22) Filed: Apr. 1, 2026

(30) Foreign Application Priority Data
Apr. 1, 2025 (JP) 2025-060419

(51) Int. Cl. G06K 15/02

(52) U.S. Cl. CPC G06K 15/1807

(57) ABSTRACT

According to an aspect of the present disclosure, there is provided a printing management device including a receiving unit configured to receive, from an external terminal operated by a user, information relating to a book to be purchased, a determination unit configured to determine, based on the information received by the receiving unit, processing that should be executed, and an instruction unit configured to instruct, based on the determination of the determination unit, a printing device to perform processing relating to printing of the book. The receiving unit is capable of receiving pre-purchase information including information for specifying the book selected by the user via the external terminal and purchase processing information including information relating to purchase processing for the book by the user, and the determination unit determines execution of printing preparation for the book based on the reception of the pre-purchase information and determines, based on the reception of the purchase processing information, to print the book.

The present application is based on, and claims priority from JP Application Serial Number 2025-060419, filed Apr. 1, 2025, the disclosure of which is hereby incorporated by reference herein in its entirety.

### BACKGROUND

### 1. Technical Field

The present disclosure relates to a printing management device and a printing system that manage book printing.

### 2. Related Art

As a countermeasure for a case in which a book is out of stock in a bookstore, as disclosed in JP-A-2010-134680, there is known on-demand printing in which printing and bookbinding are performed using a printing and bookbinding device installed in the bookstore and a printed and bound book is delivered to a purchasing user.

In a print sales management system described in JP-A-2010-134680, in view of the fact that a waiting time for printing and bookbinding occurs for the user, a viewing restriction for content in a viewing terminal is released during the waiting time to enable the user to freely view the content.

JP-A-2010-134680 is an example of the related art.

As explained above, in the print sales management system described in JP-A-2010-134680, the user is permitted to view the content on the viewing terminal during the waiting time for the printing and bookbinding. However, since the user is kept waiting until the printing and bookbinding are completed, there is room for improvement from this viewpoint.

### SUMMARY

According to an aspect of the present disclosure, there is provided a printing management device including: a receiving unit configured to receive, from an external terminal operated by a user, information relating to a book to be purchased; a determination unit configured to determine, based on the information received by the receiving unit, processing that should be executed; and an instruction unit configured to instruct, based on the determination of the determination unit, a printing device to perform processing relating to printing of the book, wherein the receiving unit is capable of receiving pre-purchase information including information for specifying the book selected by the user via the external terminal and purchase processing information including information relating to purchase processing for the book by the user, and the determination unit determines execution of printing preparation for the book based on the reception of the pre-purchase information and determines, based on the reception of the purchase processing information, to print the book.

According to an aspect of the present disclosure, there is provided a printing system including the printing management device and the printing device. According to an aspect of the present disclosure, there is provided a printing system including the printing management device and the external terminal. According to an aspect of the present disclosure, there is provided a printing system including the printing management device, the external terminal, and the printing device.

### BRIEF DESCRIPTION OF THE DRAWINGS

FIG. 1 is a diagram illustrating an overall configuration of a printing system.

FIG. 2 is a block diagram illustrating a configuration of a bookstore server.

FIG. 3 is a block diagram illustrating a configuration of a user operation terminal.

FIG. 4 is a block diagram illustrating a configuration of a printing device.

FIG. 5 is a flowchart illustrating a flow of processing in the printing system.

FIG. 6 is a diagram illustrating an example of a cover displayed in a bookstore.

FIG. 7 is a diagram illustrating an example of a UI implemented in the user operation terminal.

FIG. 8 is a diagram illustrating an example of a UI implemented in the user operation terminal.

FIG. 9 is a flowchart illustrating a flow of processing in the printing system.

FIG. 10 is a flowchart illustrating a flow of processing of stopping printing preparation.

FIG. 11 is a flowchart illustrating a flow of processing performed when pre-purchase information is received from a plurality of user operation terminals.

FIG. 12 is a flowchart illustrating the flow of processing performed when pre-purchase information is received from the plurality of user operation terminals.

FIG. 13 is a flowchart illustrating a flow of processing performed when printing is performed using a plurality of printing devices.

FIG. 14 is a flowchart illustrating a flow of processing performed when pre-purchase information is received from the plurality of user operation terminals.

FIG. 15 is a flowchart illustrating a flow of processing of combining parts of a plurality of books.

FIG. 16 is a block diagram illustrating a configuration of a bookstore server including a trained model.

FIG. 17 is a flowchart illustrating a flow of processing performed using the trained model.

### DESCRIPTION OF EMBODIMENTS

The present disclosure is schematically explained below.

According to a first aspect of the present disclosure, there is provided a printing management device including: a receiving unit configured to receive, from an external terminal operated by a user, information relating to a book to be purchased; a determination unit configured to determine, based on the information received by the receiving unit, processing that should be executed; and an instruction unit configured to instruct, based on the determination of the determination unit, a printing device to perform processing relating to printing of the book, wherein the receiving unit is capable of receiving pre-purchase information including information for specifying the book selected by the user via the external terminal and purchase processing information including information relating to purchase processing for the book by the user, and the determination unit determines execution of printing preparation for the book based on the reception of the pre-purchase information and determines, based on the reception of the purchase processing information, to print the book.

According to this aspect, since the determination unit determines the execution of the printing preparation for the book based on the reception of the pre-purchase information, it is possible to reduce a waiting time of the user until the book is completed as compared with the related art method of starting the printing preparation for the book after the user actually performs the purchase operation for the book and executing the printing.

A second aspect is an aspect dependent from the first aspect, wherein the printing preparation includes generation of print data.

According to this aspect, since the printing preparation includes the generation of the print data, it is possible to quickly start the printing after the user actually performs the purchase operation for the book and it is possible to effectively reduce the waiting time.

A third aspect is an aspect dependent from the first aspect, wherein, in the printing management device described above, the printing preparation includes a preparation operation in the printing device.

According to this aspect, since the printing preparation includes the preparation operation in the printing device, it is possible to reduce a time from when the user actually performs the purchase operation for the book until when the user starts the printing and it is possible to effectively reduce the waiting time.

This aspect may be dependent from not only the first aspect but also the second aspect.

A fourth aspect is an aspect dependent from the first aspect, wherein the pre-purchase information includes information concerning content of the book being previewed in the external terminal, and the determination unit determines execution of the printing preparation for the book when the content of the book is previewed in the external terminal.

When the user is previewing the content of the book in the external terminal, it can be said that the user is highly likely to purchase the book. According to this aspect, since the determination unit determines the execution of the printing preparation for the book when the content of the book is previewed in the external terminal, it is possible to prevent the printing preparation from being wasted and it is possible to reduce the waiting time of the user until the book is completed.

This aspect may be dependent from not only the first aspect but also the second or third aspect.

A fifth aspect is an aspect dependent from the first aspect, wherein the determination unit determines to stop the printing preparation when a predetermined condition is satisfied after determining to execute the printing preparation.

According to this aspect, since the determination unit determines to stop the printing preparation when the predetermined condition is satisfied after determining to execute the printing preparation, it is possible to suppress a problem involved in continuing the printing preparation.

This aspect may be dependent from not only the first aspect but also any one of the second to fourth aspects.

A sixth aspect is an aspect dependent from the fifth aspect, wherein the predetermined condition includes information received from the external terminal and relating to an action of the user on the external terminal.

For example, when the user has viewed information concerning a certain first book and then has viewed information concerning another second book, it can be said that the probability of purchasing the first book tends to be low. According to this aspect, since the predetermined condition includes the information received from the external terminal and relating to the action of the user on the external terminal, it is possible to prevent the stop of the printing preparation from becoming inappropriate processing.

A seventh aspect is an aspect dependent from the fifth aspect, wherein the predetermined condition includes information relating to execution status of the printing preparation.

For example, when it takes a long time for the user to decide whether to execute a purchase procedure of the book after the printing preparation is completed, it is likely that various problems are caused, for example, unnecessary power consumption occurs in the printing device and a storage area for print data is consumed in the printing management device. However, according to this aspect, since the predetermined condition includes the information relating to the execution status of the printing preparation, it is possible to suppress the problems described above.

This aspect may be dependent from not only the fifth aspect but also the sixth aspect.

An eighth aspect is an aspect dependent from the first aspect, wherein the printing preparation includes generation of print data, when the external terminal is set as a first external terminal, the receiving unit is capable of receiving the pre-purchase information from a second external terminal different from the first external terminal, and the determination unit determines, based on reception of the pre-purchase information relating to a first book selected in the first external terminal, to execute the printing preparation for first partial book information, which is a part obtained by dividing information relating to the first book, and determines, based on reception of the pre-purchase information relating to a second book selected in the second external terminal, to execute the printing preparation for second partial book information, which is a part obtained by dividing information relating to the second book.

According to this aspect, when a plurality of users are selecting books, it is possible to improve the convenience for the plurality of users by performing the printing preparation for the respective users. By performing the printing preparation for a part of a book rather than performing the printing preparation for the entire book, it is possible to suppress a load of data generation and it is possible to suppress use of a data storage area.

This aspect may be dependent from not only the first aspect but also any one of the second to seventh aspects.

A ninth aspect is an aspect dependent from the eighth aspect, wherein, when the receiving unit receives the purchase processing information for the second book subsequently to the purchase processing information for the first book, the determination unit determines to perform printing that is based on the second partial book information subsequently to printing that is based on the first partial book information.

According to this aspect, when a plurality of users have purchased books, it is possible to improve the convenience for a user who has purchased a book next compared with a method of printing the entire first book of a user who has determined the purchase first and then printing the entire second book of a user who has determined the purchase next. That is, since parts of the books can be provided to, before the printing of the entire books is completed, the user who has determined the purchase first and the user who has determined the purchase next, the users can view the parts of the books in waiting times.

A tenth aspect is an aspect dependent from the ninth aspect, wherein, when a range of the first partial book information in a case in which a number of standby jobs for which printing by the printing device is not completed is a first number is set as a first range and a range of the first partial book information in a case in which the number of standby jobs is a second number larger than the first number is set as a second range, the determination unit expands the second range to be larger than the first range.

When the number of standby jobs increases, the waiting time of the user also increases. However, according to this aspect, since the determination unit expands the second range to be larger than the first range, a printing range that can be viewed by the user increases when the waiting time of the user increases and it is possible to improve the convenience for the user.

An eleventh aspect is an aspect dependent from the eighth aspect, wherein, when the printing device is set as a first printing device and the printing device different from the first printing device is set as a second printing device, the determination unit determines to perform the printing preparation concerning the first partial book information in the first printing device and determines to perform the printing preparation concerning the second partial book information in the second printing device.

According to this aspect, when a plurality of users are viewing books, it is possible to further improve the convenience for the plurality of users by performing the printing preparation for the respective users in separate printing devices.

A twelfth aspect is an aspect dependent from the first aspect, wherein, when the external terminal is set as a first external terminal, the receiving unit is capable of receiving the pre-purchase information from a second external terminal different from the first external terminal, when the printing device is set as a first printing device, the instruction unit instructs a second printing device different from the first printing device to perform the processing relating to the printing of the book, and the determination unit determines, based on reception of the pre-purchase information relating to a first book selected in the first external terminal, to perform the printing preparation for the first book in the first printing device and determines, based on reception of the pre-purchase information relating to a second book selected in the second external terminal, to perform the printing preparation for the second book in the second printing device.

According to this aspect, when a plurality of users are selecting books, it is possible to improve the convenience for the plurality of users by performing printing preparation for the respective users in separate printing devices.

This aspect may be dependent from not only the first aspect but also any one of the second to seventh aspects.

A thirteenth aspect is an aspect dependent from the first aspect, wherein, when the printing device is set as a first printing device, the instruction unit instructs a second printing device different from the first printing device to perform the processing relating to the printing of the book, the determination unit determines to perform the printing preparation concerning a first portion, which is a part of the book, in the first printing device, and, when the receiving unit receives the purchase processing information, the determination unit further determines to perform printing in the first printing device for the first portion and determines to perform printing in the second printing device for a second portion, which is a part of the book and is other than the first portion.

According to this aspect, by printing one book in a plurality of printing devices, it is possible to reduce a printing time in printing the one book.

This aspect may be dependent from not only the first aspect but also any one of the second to seventh aspects.

A fourteenth aspect is an aspect dependent from the thirteenth aspect, wherein, when a number of the external terminals that transmitted the pre-purchase information is smaller than a number of the printing devices that the instruction unit instructs to perform the processing relating to the printing of the book, the determination unit determines to perform the printing in the first printing device for the first portion and determines to perform the printing in the second printing device for the second portion.

When the number of the external terminals that have transmitted the pre-purchase information is smaller than the number of the printing devices that the instruction unit can instruct to perform the processing relating to the printing of the book, by printing the one book in a plurality of printing devices, it is possible to reduce the printing time in printing the one book.

A fifteenth aspect is an aspect dependent from the first aspect, wherein the determination unit executes a mode for setting, as a target of the printing preparation and the printing by the printing device, a combined book formed by combining a part of a first book serving as the book and a part of a second book different from the first book.

According to this aspect, since the determination unit can execute the mode for setting, as the target of the printing preparation and the printing by the printing device, the combined book formed by combining a part of the first book serving as the book and a part of the second book different from the first book, the convenience for the user is improved.

This aspect may be dependent from not only the first aspect but also any one of the second to fourteenth aspects.

A sixteenth aspect is an aspect dependent from the first aspect, wherein, when a number of the external terminals that transmitted the pre-purchase information is larger than a number of the printing devices that the instruction unit instructs to perform the processing relating to the printing of the book, the determination unit determines to, in order of reception of the purchase processing information by the receiving unit, perform the printing using the printing device having a smallest number of standby jobs for which the printing is not completed.

According to this aspect, when the number of the external terminals that have transmitted the pre-purchase information is larger than the number of the printing devices that the instruction unit can instruct to perform the processing relating to the printing of the book, the determination unit determines to, in the order of the reception of the purchase processing information by the receiving unit, perform the printing using the printing device having the smallest number of standby jobs for which the printing has not been completed. Therefore, it is possible to suppress the waiting time of the user to the maximum.

This aspect may be dependent from not only the first aspect but also any one of the second to fifteenth aspects.

A seventeenth aspect is an aspect dependent from the first aspect, wherein, when the external terminal is set as a first external terminal, the receiving unit is capable of receiving the pre-purchase information from a second external terminal different from the first external terminal, when the printing device is set as a first printing device, the instruction unit instructs a second printing device different from the first printing device to perform the processing relating to the printing of the book, and, when the determination unit determines to perform, in the first printing device, the printing preparation concerning a first book selected in the first external terminal and the printing preparation concerning a second book selected in the second external terminal and the receiving unit receives the purchase processing information relating to the second book after the reception of the purchase processing information relating to the first book, the determination unit compares a first estimated time until completion of printing of the first book in the first printing device and a second estimated time in a case in which the printing preparation relating to the second book is performed in the second printing device and, when the first estimated time is longer than the second estimated time, discards the printing preparation concerning the second book in the first printing device and determines to perform the printing preparation and the printing concerning the second book in the second printing device.

According to this aspect, when the first estimated time is longer than the second estimated time, the printing preparation concerning the second book in the first printing device is discarded and it is determined to perform the printing preparation and the printing concerning the second book in the second printing device. Therefore, it is possible to effectively suppress the waiting time of the user by efficiently using a plurality of the printing devices.

An eighteenth aspect is a printing management device that instructs a printing device to print a book, the printing management device including: a receiving unit configured to receive, from an operation terminal for performing purchase of the book, information relating to a user action on the operation terminal; an estimation unit configured to estimate, based on the user action, using a trained model generated by machine learning based on labeled training data, a probability that a user purchases the book; and a determination unit configured to determine, based on the probability estimated by the estimation unit, whether to perform printing preparation for the book, wherein the labeled training data includes a combination of the information relating to the user action and whether the user purchased the book and, when the probability estimated by the estimation unit exceeds a predetermined value, execution of the printing preparation is determined.

According to this aspect, it is possible to highly accurately estimate, using the trained model, the probability that the user purchases the book. Since the determination unit determines the execution of the printing preparation based on the probability, it is possible to prevent the printing preparation from being wasted.

A nineteenth aspect is an aspect dependent from the eighteenth aspect, the user action including a viewing time of the information relating to the book in the operation terminal.

As the viewing time of the information relating to the book in the operation terminal is longer, the user tends to purchase the book more.

According to this aspect, since the user action includes the viewing time of the information relating to the book in the operation terminal, it is possible to highly accurately estimate the probability that the user purchases the book.

A twentieth aspect is a printing system including: the printing management device according to any one of the first to nineteenth aspects; and the printing device.

According to this aspect, in the printing system, the action effects of any one of the first to nineteenth aspects explained above can be obtained.

A twenty-first aspect is a printing system including: the printing management device according to any one of the first to nineteenth aspects; and the external terminal.

According to this aspect, in the printing system, the action effects of any one of the first to nineteenth aspects explained above can be obtained.

A twenty-second aspect is a printing system including: the printing management device according to any one of the first to nineteenth aspects; the external terminal; and the printing device.

According to this aspect, in the printing system, the action effects of any one of the first to nineteenth aspects explained above can be obtained.

The present disclosure is specifically explained below.

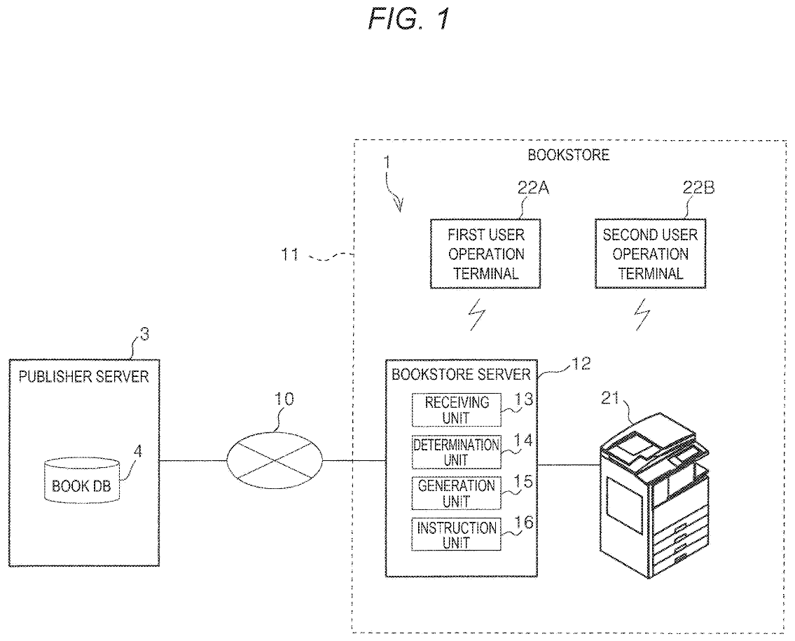

In FIG. 1, reference numeral 11 denotes a bookstore and the bookstore 11 includes a printing system 1. In the present embodiment, the printing system 1 includes a bookstore server 12, a first user operation terminal 22A, a second user operation terminal 22B, and a printing device 21. Hereinafter, when the first user operation terminal 22A and the second user operation terminal 22B are not distinguished from each other, the first user operation terminal 22A and the second user operation terminal 22B are collectively referred to as user operation terminal 22. The bookstore server 12 is connected to the Internet 10. A publisher server 3 installed at the outer side of the bookstore 11 is connected to the Internet 10.

In FIG. 1, as an example, one bookstore server 12, two user operation terminals 22, one printing device 21, and one publisher server 3 are illustrated. However, the numbers of the devices are not limited thereto.

The printing system 1 includes at least one printing management device. In the present embodiment, the printing management device includes the bookstore server 12. The printing system 1 is a system for performing so-called on-demand printing and is a system for printing, in a printing device 21, a book out of stock in a bookstore and selling the book to a user. The user operates the user operation terminal 22, which is an example of an external terminal, to perform purchase operation for a desired book. The bookstore server 12 instructs the printing device 21 to print the book based on information transmitted from the user operation terminal 22. The bookstore server 12 sometimes instructs the printing device 21 to perform printing preparation. This is explained below.

In the present embodiment, the bookstore server 12 is a general server device and includes functional parts such as a receiving unit 13, a determination unit 14, a generation unit 15, and an instruction unit 16. The receiving unit 13 receives, from the user operation terminal 22, information relating to a book to be purchased. The information includes pre-purchase information and purchase processing information explained below. The determination unit 14 determines, based on the information received by the receiving unit 13, processing that should be executed. The generation unit 15 generates print data. The instruction unit 16 instructs, based on the determination of the determination unit 14, the printing device 21 to perform processing relating to printing of the book. The instruction of the processing relating to the printing of the book includes an instruction of printing preparation and an instruction of printing execution explained below.

The functional parts explained above are parts focusing on the functions of the bookstore server 12 and are implemented by the bookstore server 12 executing a program. Therefore, the functional parts are not always respectively implemented by separate programs. A plurality of or all functional units are sometimes implemented by one program.

A functional unit including the functional parts of the receiving unit 13, the determination unit 14, the generation unit 15, and the instruction unit 16 may be referred to as printing control unit.

The printing device 21 is a printing device that performs printing on a medium based on print data transmitted from the bookstore server 12 and, in the present embodiment, is an inkjet printer that performs printing by ejecting ink, which is an example of liquid, onto paper, which is an example of a medium. The printing device 21 has a post-processing function of performing post-processing after printing and can perform, as an example, saddle stitching processing by a stapler. The post-processing may also be referred to as bookbinding processing. The post-processing is not limited to the saddle stitching processing described above and may be other processing such as punching processing of punching the medium and shift discharge processing of alternately shifting a discharge position of a medium bundle and discharging the medium bundle or a plurality of kinds of processing among these kinds of processing may be executable.

In the present embodiment, the publisher server 3 is a general server device including a CPU, a memory, a storage, and the like not illustrated in the figure and includes a book database 4. In the figure and the following explanation, a term “database” is written as “DB”. The book DB 4 includes, as electronic data, a book to be purchased by the user using the user operation terminal 22. The bookstore server 12 makes a transmission request for book data to the publisher server 3 based on information relating to a book transmitted from the user operation terminal 22. The publisher server 3 transmits the book data to the bookstore server 12 in response to the transmission request.

A part or the entire book DB 4 may be provided in the bookstore server 12.

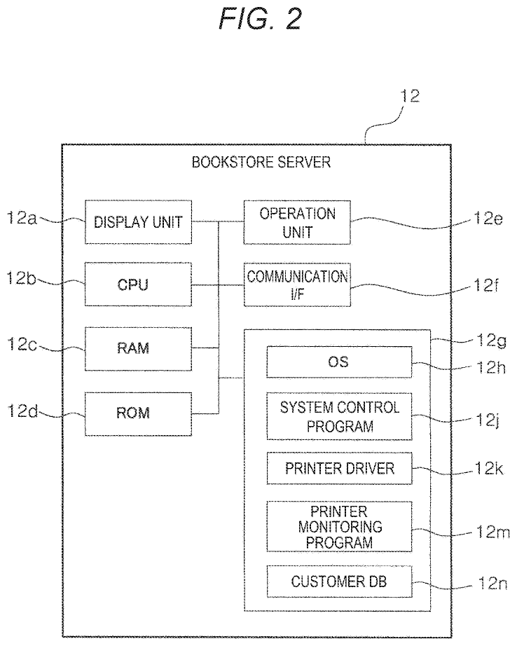

Hereinafter, a configuration of the bookstore server 12 is explained with reference to FIG. 2.

The bookstore server 12 includes an operation unit 12e, a display unit 12a, a CPU 12b, a RAM 12c, a ROM 12d, a communication interface 12f, and a storage 12g. In the figure and the following explanation, a term “interface” is written as “I/F”.

The storage 12g includes an information storage device such as a hard disk drive (HDD) or a solid state drive (SSD). The storage 12g stores various programs and various data such as an operating system 12h, a system control program 12j, a printer driver 12k, a printer monitoring program 12m, and a customer DB 12n. In the figure and the following explanation, a term “operating system” is written as “OS”.

The system control program 12j is a program for controlling the entire printing system 1. Various kinds of processing performed by the bookstore server 12 explained below are implemented by the system control program 12j being executed unless particularly referred to otherwise. In particular, a function of the determination unit 14 (see FIG. 1) is implemented by the system control program 12j.

The printer driver 12k and the printer monitoring program 12m are used for printing performed using the printing device 21. When performing printing preparation explained below, the OS 12h starts the printer driver 12k and the printer driver 12k starts the printer monitoring program 12m. The printer driver 12k generates print data based on the book data. That is, a function of the generation unit 15 (see FIG. 1) is implemented by the printer driver 12k. The generated print data is transmitted to the printing device 21 through a not-illustrated spooler.

The printer monitoring program 12m is a program that is sometimes called status monitor as well and a basic function of the printer monitoring program 12m is to communicate with the printing device 21 and discriminate abnormalities such as paper jam, out of ink, or cover open. When the abnormalities described above have occurred, the printer monitoring program 12m displays abnormality content on the display unit 12a and notifies the administrator of the bookstore server 12, for example, a store clerk of the bookstore 11.

The customer DB 12n includes various information for the user to log in to the printing system 1 using the user operation terminal 22.

The CPU 12b loads, in the RAM 12c, which is a volatile memory, various programs and the like stored in the ROM 12d and the storage 12g and executes the programs and the like.

The operation unit 12e includes a keyboard and a pointing device such as a mouse or a touch pad not illustrated in the figure.

The display unit 12a includes a liquid crystal display.

The communication I/F 12f includes a communication interface for connecting the bookstore server 12 to the Internet 10 and an interface for communicating with the user operation terminal 22.

The bookstore server 12 may be installed at the outer side of the bookstore 11. For example, the bookstore server 12 may be connected to the bookstore 11 via the Internet 10.

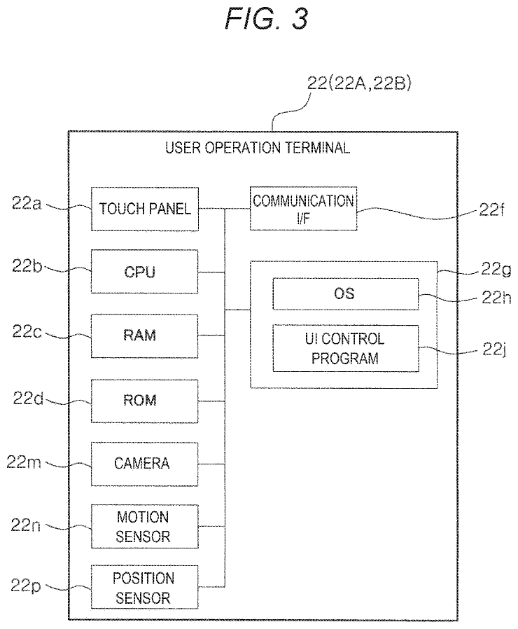

Hereinafter, a configuration of the user operation terminal 22 is explained with reference to FIG. 3.

The user operation terminal 22 includes a touch panel 22a, a CPU 22b, a RAM 22c, a ROM 22d, a communication I/F 22f, a storage 22g, a camera 22m, a motion sensor 22n, and a position sensor 22p.

The storage 22g includes an information storage device such as a flash memory. The storage 22g stores various programs such as an operating system 22h and a UI control program 22j and various data.

The UI control program 22j is a program for controlling display of the touch panel 22a, specifically, display of a user interface. Unless particularly referred to, various kinds of processing performed by the user operation terminal 22 explained below are implemented by the UI control program 22j being executed. In the present specification and the drawings, a term “user interface” is written as “UI”.

The CPU 22b loads, in the RAM 22c, which is a volatile memory, various programs and the like stored in the ROM 22d and the storage 22g and executes the programs and the like.

The touch panel 22a displays various information and receives various kinds of operation by the user.

The communication I/F 22f includes a communication interface for connecting the user operation terminal 22 to the bookstore server 12.

The camera 22m is a camera for mainly reading a barcode explained below.

The motion sensor 22n detects a movement, a tilt, and the like of the user operation terminal 22.

The position sensor 22p is a sensor for detecting the position of the user operation terminal 22 and may include a plurality of sensors among an acceleration sensor, a gyro sensor, a geomagnetic sensor, a GPS, and the like.

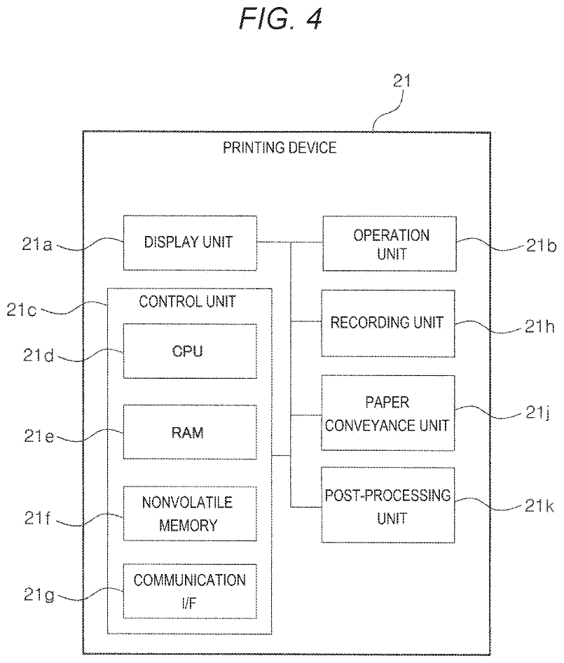

Hereinafter, a configuration of the printing device 21 is explained with reference to FIG. 4.

The printing device 21 includes an operation unit 21b, a display unit 21a, a control unit 21c, a recording unit 21h, a paper conveyance unit 21j, and a post-processing unit 21k. The control unit 21c includes a CPU 21d, a RAM 21e, a nonvolatile memory 21f, and a communication I/F 21g.

In the control unit 21c, the CPU 21d loads, in the RAM 21e, which is a volatile memory, various control programs and the like stored in the nonvolatile memory 21f and executes the control programs and the like.

The operation unit 21b includes a numeric keypad, a cross button, an OK button, and a return button not illustrated in the figure.

The display unit 21a includes a liquid crystal display. The display unit 21a displays a UI for performing various settings and various kinds of operation of the printing device 21.

The communication I/F 21g includes a communication interface for connecting the printing device 21 to the bookstore server 12 and the Internet 10.

The recording unit 21h includes a not-illustrated inkjet recording head. The paper conveyance unit 21j includes a not-illustrated paper conveyance roller.

The post-processing unit 21k includes a not-illustrated binding processing mechanism. The post-processing unit can also be referred to as a bookbinding device.

The printing device 21 is not limited to the inkjet printer and may be configured to perform printing with another scheme, such as a laser printer.

The printing device 21 may not include the post-processing unit 21k. The printing device 21 and the post-processing unit 21k may be separately configured.

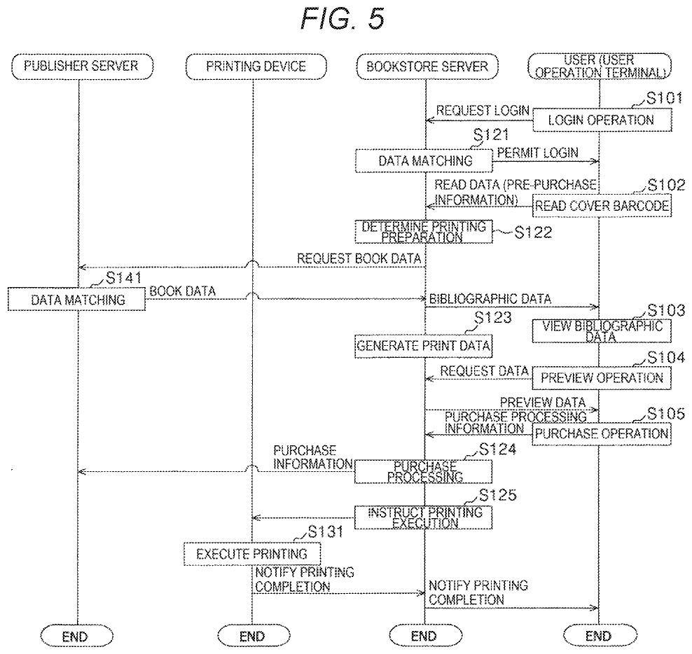

Next, an example of a flow of processing in printing a book in the printing system 1 is explained with reference to FIG. 5.

First, in the bookstore 11, the user performs, using the user operation terminal 22, login operation for specifying the user (step S101). In response to the login operation, the user operation terminal 22 makes a login request to the bookstore server 12. In response to the login request, the bookstore server 12 performs data matching based on the customer DB 12n (see FIG. 2) (step S121) and permits login when the data is successfully matched. Various kinds of operation in the user operation terminal 22 explained below may be executable without performing the login operation.

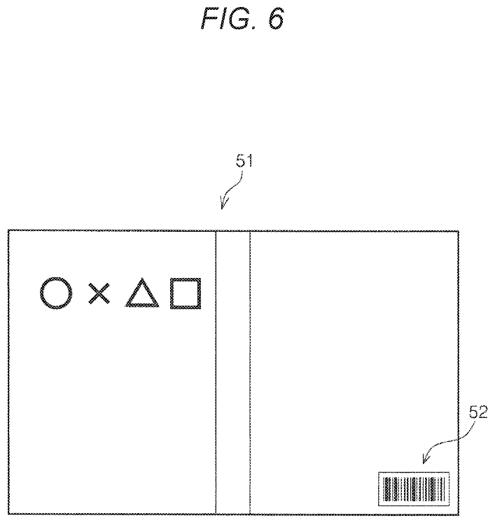

Next, the user uses a camera function of the user operation terminal 22 to read a barcode attached to a cover of a book displayed in the bookstore 11 (step S102). A cover 51 illustrated in FIG. 6 is an example of the cover of the book. Although the cover described above is displayed in the bookstore 11, there is only the cover and there is no main body of the book. Therefore, the bookstore 11 does not substantially need to have a stock of the book.

A barcode 52 is attached to the cover 51. The barcode 52 is for specifying the book and is a book name or an ISBN code converted into a barcode. Read data of the barcode 52 is an example of information for specifying a book selected by the user via the user operation terminal 22 and constitutes pre-purchase information.

In FIG. 5, when the user performs operation of reading the barcode 52 (step S102), the user operation terminal 22 transmits read data to the bookstore server 12. The read data is an example of information relating to a book to be purchased by the user. The receiving unit 13 (see FIG. 1) plays a role of receiving the read data in the bookstore server 12.

In response to the read data, the bookstore server 12 determines to perform printing preparation (step S122). This determination processing may be, as an example, determination processing for proceeding to step S123 explained below. Specifically, when determination processing of determining Yes when the read data is received is provided, Yes being determined in the determination processing may be regarded as determining the printing preparation.

Then, the bookstore server 12 requests the publisher server 3 to transmit book data. In response to the request, the publisher server 3 performs data matching based on the book DB 4 (see FIG. 1) (step S141) and transmits the book data to the bookstore server 12 when a relevant book is present as data. The book data includes all data necessary for printing the entire book. In response to the transmission of the book data, the bookstore server 12 transmits bibliographic data to the user operation terminal. Here, the bibliographic data includes a book name, a publisher, a book price, a summary of the book, and the like and does not include data of content of the book. The bibliographic data may include, for example, data for previewing several pages at the beginning of the book.

When the book data has a large volume and it takes time for communication, the bibliographic data and the book data may be separately transmitted from the publisher server 3, that is, the bibliographic data may be transmitted first and then the book data may be transmitted. The bibliographic data may be stored in the storage 12g of the bookstore server 12 or both of the bibliographic data and the book data may be stored in the storage 12g of the bookstore server 12.

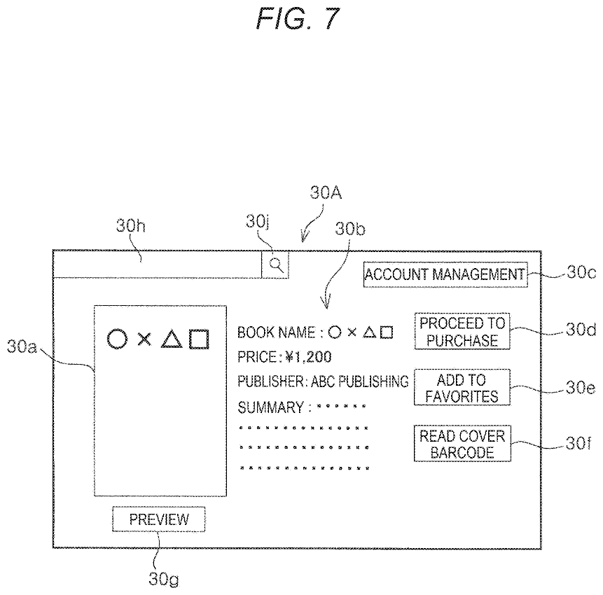

When receiving the bibliographic data, the user operation terminal 22 displays bibliographic information on the touch panel 22a (see FIG. 3) and the user views the bibliographic information (step S103). A UI 30A illustrated in FIG. 7 is a UI displayed on the user operation terminal 22 and indicates an example of a state in which bibliographic information 30b is displayed.

In the UI 30A, a cover image 30a is illustrated and bibliographic information 30b including a book name, a price, a publisher, and a summary is displayed next to the cover image 30a.

A search window 30h is provided in the UI 30A. The user can also acquire the bibliographic information by inputting characters to the search window 30h and tapping a search button 30j instead of reading the barcode. In this case, the user operation terminal 22 transmits search information to the bookstore server 12 and the bookstore server 12 makes an inquiry request to the publisher server 3. The publisher server 3 transmits search results to the bookstore server 12, the bookstore server 12 transmits the search results to the user operation terminal 22, and the user operation terminal 22 displays the search results on the touch panel 22a as a list. Operation of the user tapping one of the search results displayed as the list is operation equivalent to the reading the cover barcode (step S102).

In the UI 30A, an account management button 30c, a “proceed to purchase” button 30d, an “add to favorites” button 30e, a “read cover barcode” button 30f, and a “preview” button 30g are displayed.

When the user taps the account management button 30c, the UI 30A transitions to a not-illustrated account management UI and the user can perform various kinds of account-related setting processing for setting a user ID, a password, a default payment method, and the like.

When the user taps the “proceed to purchase” button 30d, the account management UI transitions to a not-illustrated purchase processing UI and the user can decide the purchase of the book after designating a payment method or the like.

When the user taps the “add to favorites” button 30e, the book being displayed is registered in a favorite list.

When the user taps the “read cover barcode” button 30f, a barcode is read by the camera function of the user operation terminal 22.

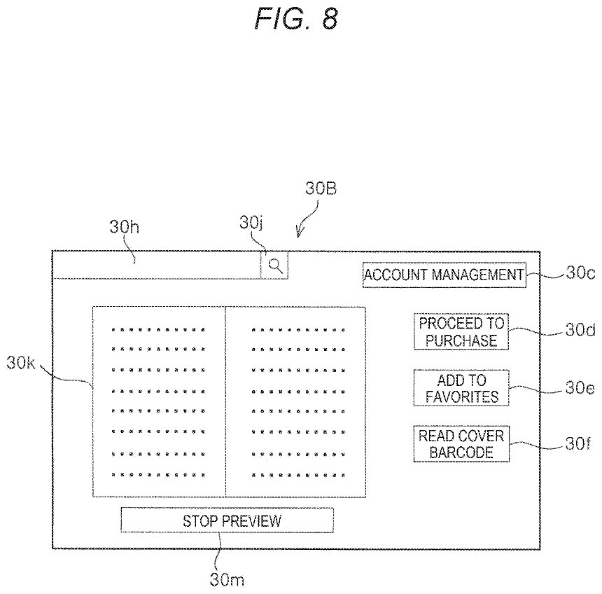

When the user taps the “preview” button 30g, the purchase processing UI transitions to a UI 30B illustrated in FIG. 8 and the user can preview a part of the book. In FIG. 8, reference numeral 30k denotes a preview image. When the user taps a “stop preview” button 30m in FIG. 8, the UI 30B returns to the UI 30A illustrated in FIG. 7.

The UI control in the user operation terminal 22 explained above is performed by the UI control program 22j (see FIG. 3).

Referring back to FIG. 5, when receiving the book data from the publisher server 3, the bookstore server 12 generates print data (step S123). At this time point, the user has not decided whether to actually purchase the book. However, when the user reads the barcode of the book (step S102), it can be said that the user is more likely to purchase the book. Therefore, the bookstore server 12 starts generating the print data. The generation unit 15 (see FIG. 1) plays a role of generating the print data.

When the user taps the “preview” button 30g (see FIG. 7) (step S104) as explained above, the user operation terminal 22 requests the bookstore server 12 to transmit data necessary for preview. In response to the request, the bookstore server 12 transmits preview data to the user operation terminal 22. Then, the user operation terminal 22 displays the preview image 30k (see FIG. 8). The preview data may be, for example, data for previewing several pages at the beginning of the book or may be data for previewing the entire book. When the preview data is the data for previewing the entire book, a predetermined restriction such as a restriction on a preview time may be provided.

Subsequently, when the user performs book purchase operation (step S105), the user operation terminal 22 transmits purchase processing information to the bookstore server 12. The purchase processing information includes book information and, for example, if a settlement method is a credit card, card information.

In response to the transmission of the purchase processing information, the bookstore server 12 performs purchase processing (step S124). The purchase processing includes, for example, if the settlement method is the credit card, transmission of information such as card information and purchase content to a credit card company and reception of settlement completion information from the credit card company. Information indicating that the book has been purchased is transmitted to the publisher server 3.

Then, the bookstore server 12 instructs the printing device 21 to execute printing (step S125). In response to the instruction, the printing device 21 executes printing of the book (step S131). The instruction unit 16 (see FIG. 1) plays a role of instructing the printing device 21 to execute the printing.

In the printing device 21, a plurality of paper discharge ports may be provided and the paper discharge ports may be fixed for each customer. In this way, mixing of prints among customers is suppressed.

The user may be capable of selecting print paper. Accordingly, the user can, for example, select plain paper for a book and select photo paper if there are many photos.

When the printing is completed, the printing device 21 notifies the bookstore server 12 to that effect. In response to the notification, the bookstore server 12 notifies the user operation terminal 22 that the printing has been completed.

In response to the notification, the user operation terminal 22 may display a flow of the subsequent processing on a UI of the touch panel 22a. For example, if the cover 51 illustrated in FIG. 6 is used as it is, a method of setting the cover 51 on a printing completed product may be informed.

Here, one of the characteristics of the printing system 1 is explained.

As explained with reference to FIGS. 1 and 5, the receiving unit 13 of the bookstore server 12 is capable of receiving, from the user operation terminal 22 operated by the user, the information relating to the book to be purchased.

The determination unit 14 determines, based on the information received by the receiving unit 13, processing that should be executed.

The instruction unit 16 instructs, based on the determination of the determination unit 14, the printing device 21 to perform processing relating to printing of the book.

The receiving unit 13 is capable of receiving, via the user operation terminal 22, the pre-purchase information including the information for specifying the book selected by the user and the purchase processing information including the information relating to the purchase processing for the book by the user.

Then, the determination unit 14 determines, based on the reception of the pre-purchase information, to execute the printing preparation for the book (step S122) and determines, based on the reception of the purchase processing information, to print the book (step S124).

With the printing system 1 explained, since the determination unit 14 performs the printing preparation before the user actually performs the purchase operation for the book, it is possible to reduce a waiting time of the user until the book is completed as compared with the method of the related art in which the printing preparation for the book is started after the user actually performs the purchase operation for the book and then the printing is executed.

In the present embodiment, the determination unit 14 determining the execution of the printing preparation means that the printing preparation is actually performed in at least one of the bookstore server 12 and the printing device 21 before the user actually performs the purchase operation for the book.

In the embodiment explained above, the printing management device of the printing system 1 includes the bookstore server 12. However, the printing device 21 may have the function of the printing management device, that is, the bookstore server 12. Specifically, at least one or all of the receiving unit 13, the determination unit 14, the generation unit 15, and the instruction unit 16 illustrated in FIG. 1 may be provided in the printing device 21.

The user operation terminal 22 may have the function of the printing management device, that is, the bookstore server 12. Specifically, at least one or all of the receiving unit 13, the determination unit 14, the generation unit 15, and the instruction unit 16 illustrated in FIG. 1 may be provided in the user operation terminal 22, that is, the functional units may be implemented by an application installed in the user operation terminal 22 being executed.

The user operation terminal 22 is not limited to the terminal installed in the bookstore 11 and owned by the bookstore and may be a mobile information terminal owned by the user.

The purchase operation (step S105) in the user operation terminal 22 illustrated in FIG. 5 may be performed in another terminal such as a cash register owned by the bookstore. In that case, user information is input in the other terminal.

In the example explained above, the determination unit 14 sets the read data of the barcode 52 (see FIG. 6) as the pre-purchase information and determines the printing preparation based on the reception of the pre-purchase information (step S122 in FIG. 5). However, without being limited thereto, the determination unit 14 may determine the printing preparation based on another user action on the user operation terminal 22.

For example, based on the “proceed to purchase” button 30d being tapped or the “add to favorites” button 30e being tapped in the UI 30A illustrated in FIG. 7, the determination unit 14 may determine to perform the printing preparation. This is because, when the button is tapped, it can be said that the selected book is highly likely to be purchased. In this case, the user operation terminal 22 notifies the bookstore server 12 that the button has been tapped. The notification is an example of pre-purchase information transmitted from the user operation terminal 22 to the bookstore server 12. By performing the printing preparation based on the user action with the high likelihood of purchasing the book, it is possible to prevent the printing preparation from being wasted and it is possible to reduce the waiting time of the user until the book is completed.

Based on the “preview” button 30g being tapped on the UI 30A illustrated in FIG. 7, the determination unit 14 may determine to perform the printing preparation. This is because, when the “preview” button 30g is tapped, it can be said that the selected book is highly likely to be purchased. In this case, the user operation terminal 22 notifies the bookstore server 12 that the “preview” button 30g has been tapped. The notification is an example of information concerning the content of the book being previewed in the user operation terminal 22 and is an example of the pre-purchase information transmitted from the user operation terminal 22 to the bookstore server 12. By performing the printing preparation based on the user action with the high likelihood of purchasing the book, it is possible to prevent the printing preparation from being wasted and it is possible to reduce the waiting time of the user until the book is completed.

In addition, a user action considered to have high likelihood of purchasing the book may be adopted for the determination of printing preparation. For example, when a preview time of the book is long, the book is considered to be highly likely to be purchased. Therefore, the printing preparation may be performed when a predetermined time has elapsed after the preview of the book is started. When the speed of page turning at the time of the preview is low, specifically, when a time from when a certain page is opened until when the next page is opened is longer than a predetermined time, since the book is considered to be highly likely to be purchased, the printing preparation may be performed. When the user action explained above occurs, the user operation terminal 22 notifies the bookstore server 12 to that effect.

In the example explained above, the printing preparation includes the generation of the print data (step S123). Accordingly, it is possible to quickly start printing after the user actually performs the purchase operation for the book and it is possible to effectively reduce the waiting time.

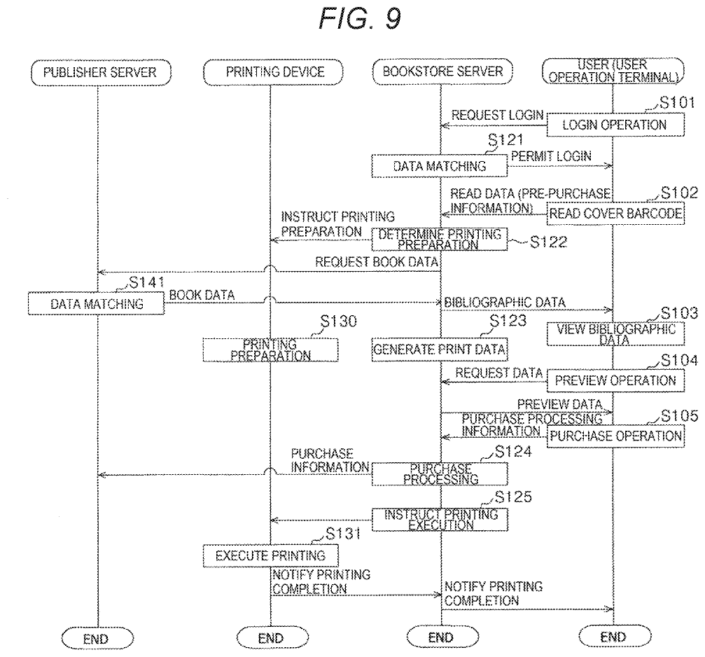

Next, a modification of the example explained above is explained with reference to FIG. 9. FIG. 9 is different from the flowchart illustrated in FIG. 5 in that the bookstore server 12 instructs the printing device 21 to perform printing preparation when the bookstore server 12 determines the printing preparation in step S122. In response to the instruction, the printing device 21 performs the printing preparation (step S130).

Examples of the printing preparation performed by the printing device 21 include return from a sleep mode, cap release, head cleaning before printing, and a paper feeding operation. Since the preparation operation in the printing device 21 is included in the printing preparation in the printing system 1 as explained above, it is possible to reduce the time from when the user actually performs the purchase operation for the book until when the printing is started and it is possible to effectively reduce the waiting time of the user.

The sleep mode is a mode for suppressing power supply when the printing device 21 does not operate and there is no operation input by the user for a predetermined time. A certain degree of time is required when returning from the sleep mode to a normal mode.

The cap release is an operation in which a cap (not illustrated) covering the inkjet recording head (not illustrated) is separated from the inkjet recording head. A certain degree of time is required for the cap release.

The head cleaning before printing is an operation of wiping an ink ejection surface of the inkjet recording head (not illustrated) with a wiper (not illustrated) or sucking ink by generating a negative pressure in the cap in a state in which the cap covers the inkjet recording head (not illustrated). A certain degree of time is required for the head cleaning.

The paper feeding operation is an operation of feeding paper from a paper feeding cassette (not illustrated) and sending the paper to a printing position.

When the printing device 21 is a laser printer, energization of a heater, charging-on of a charging drum, and the like are also examples of the printing preparation. A certain degree of time is required for these operations.

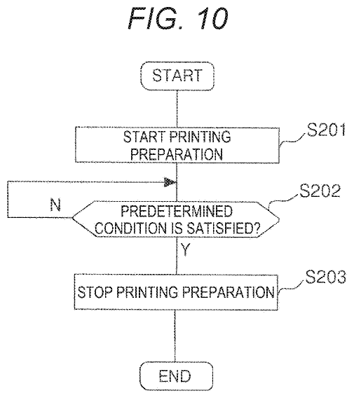

Next, a modification of the examples explained above is explained with reference to FIG. 10.

When the determination unit 14 of the bookstore server 12 determines to execute the printing preparation (step S122 in FIGS. 5 and 9), the bookstore server 12 or the printing device 21, in addition to the bookstore server 12, starts the printing preparation (step S201). However, when a predetermined condition is satisfied (Yes in step S202), the determination unit 14 determines to stop the printing preparation (step S203).

Accordingly, it is possible to suppress a problem involved in continuing the printing preparation.

The stop of the printing preparation means that, for example, if the printing preparation is generation of print data and the print data is being generated, the print data is not generated any further and the print data generated to that point is discarded and, after the print data is generated, all the completed print data is discarded. However, without being limited to being stopped, if the printing preparation is interrupted, for example, if the print data is being generated, the print data generated to that point may be held.

Examples of the problem involved in continuing the printing preparation include, since the capacity of the data storage area of the bookstore server 12, for example, the RAM 12c or the storage 12g is consumed when the print data is generated, such erosion of the data storage area. When the printing device 21 is left untouched in a cap released state for a long time, clogging occurs in an ink ejection nozzle. Therefore, such clogging is an example of the problem.

Hereinafter, the predetermined condition is explained. The predetermined condition includes information received from the user operation terminal 22 and relating to the action of the user on the user operation terminal 22.

For example, when the user views information concerning a first book and then views information concerning another second book, it can be said that the probability of purchasing the first book tends to be low. The user viewing the information concerning the first book and then viewing the information concerning the other second book is an example of the user action. When the user action occurs, the user operation terminal 22 notifies the bookstore server 12 to that effect and the determination unit 14 of the bookstore server 12 determines to stop the printing preparation based on the notification.

By stopping the printing preparation based on the user action, it is possible to prevent the stop of the printing preparation from becoming inappropriate processing.

Another example of the user action is a case in which no change is observed in the motion sensor 22n (see FIG. 3) or the position sensor 22p (see FIG. 3) of the user operation terminal 22. Other examples of the user action include a case in which the camera 22m is an in-camera that images the face of the user and the face of the user cannot be recognized by the in-camera and a case in which the user operation terminal 22 is in a non-operation state for a predetermined time and a screen is locked. This is because, in these user actions, it is considered that the user is away from the user operation terminal 22 and the probability of purchasing the book is low.

When the user operation terminal 22 is a portable information terminal owned by the user, a case in which an operation of a terminal detected by the motion sensor 22n (see FIG. 3) is intense, a case in which the position of the terminal that is based on the position sensor 22p (see FIG. 3) is out of the bookstore 11, and the like are also examples of the user action. This is because, in such cases, it is considered that the possibility of purchasing the book is low.

The predetermined condition may include information relating to execution status of the printing preparation.

For example, when it takes a long time to decide whether the user executes a purchase procedure for the book after the printing preparation is completed, it is likely that various problems are caused, for example, unnecessary power consumption occurs in the printing device 21 and the storage area for the print data is consumed in the bookstore server 12. Therefore, by including the information relating to the execution status of the printing preparation in the predetermined condition, it is possible to suppress the problems described above.

Here, the execution status of the printing preparation includes a lapse of time after the generation of the print data is completed, compression status of the data storage area of the bookstore server 12, and a power consumption amount after the printing device 21 returns from the sleep mode. This is because these execution status of the printing preparation causes adverse effects in the devices.

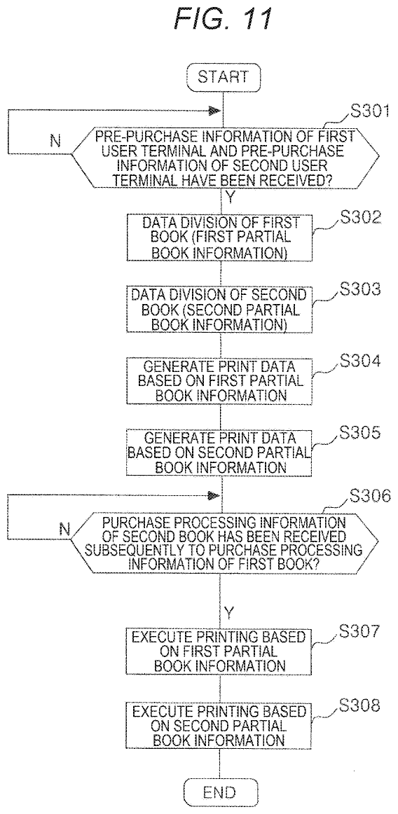

Next, a modification of the examples explained above is explained with reference to FIG. 11.

As explained with reference to FIG. 1, the receiving unit 13 of the bookstore server 12 is capable of receiving the pre-purchase information from the first user operation terminal 22A and the second user operation terminal 22B.

In FIG. 11, when receiving the pre-purchase information relating to the first book selected in the first user operation terminal 22A and the pre-purchase information relating to the second book selected in the second user operation terminal 22B (step S301), the determination unit 14 of the bookstore server 12 proceeds to step S302.

In step S302, the determination unit 14 divides information relating to the first book, that is, data of the first book and generates first partial book information. Subsequently, in step S303, the determination unit 14 divides information relating to the second book, that is, data of the second book and generates second partial book information. Here, the first partial book information is, for example, data at the beginning among the divided data of the first book and the second partial book information is, for example, data at the beginning among the divided data of the second book.

Subsequently, the determination unit 14 determines execution of the printing preparation for the first partial book information and generates print data (step S304). The determination unit 14 determines execution of the printing preparation for the second partial book information and generates print data (step S305).

According to the processing explained above, when a plurality of users are selecting books, it is possible to improve the convenience for the plurality of users by performing the printing preparation for the respective users. By performing the printing preparation for a part of a book rather than performing the printing preparation for the entire book, it is possible to suppress a load of data generation and it is possible to suppress use of a data storage area.

As the data division of the book, the entire book may be equally divided into a plurality of parts or the book may be divided in units of chapters.

Restrictions may be provided for the first partial book information and the second partial book information according to the specifications of the printing device 21. For example, an upper limit of the number of pieces of stacked paper of a processing tray (not illustrated) of the post-processing unit 21k (see FIG. 4) may be set as an upper limit of the number of pages.

Subsequently, in FIG. 11, when receiving the purchase processing information of the second book subsequently to the purchase processing information of the first book (Yes in step S306), the determination unit 14 determines printing that is based on the first partial book information and instructs the printing device 21 to execute the printing. The printing device 21 executes the printing (step S307). Following the determination of the printing that is based on the first partial book information, the determination unit 14 determines execution of printing that is based on the second partial book information and instructs the printing device 21 to execute the printing. The printing device 21 executes the printing (step S308).

According to the processing explained above, when a plurality of users have purchased books, it is possible to improve the convenience for a user who has purchased a book next compared with a method of printing an entire first book of a user who has determined the purchase first and then printing an entire second book of a user who has determined the purchase next. That is, since parts of the books can be provided to, before the printing of the entire books is completed, the user who has determined the purchase first and the user who has determined the purchase next, the users can view the parts of the books in waiting times.

In addition, a plurality of printing devices 21 may be installed, for example, one of the printing devices 21 may be set as the first printing device 21A and another one may be set as the second printing device 21B, and the determination unit 14 may determine to perform the printing preparation concerning the first partial book information in the first printing device 21A and determine to perform the printing preparation concerning the second partial book information in the second printing device 21B and then may execute the printing preparation.

According to the processing explained above, when a plurality of users are viewing books, it is possible to further improve the convenience for the plurality of users by performing printing preparation for the respective users in separate printing devices.

Ranges of the first partial book information and the second partial book information may be changed according to the number of standby jobs for which printing by the printing device 21 has not been completed. For example, when a range of the first partial book information in the case in which the number of the standby jobs is a first number is set as a first range and a range of the first partial book information in the case in which the number of the standby jobs is a second number larger than the first number is set as a second range, the determination unit 14 expands the second range to be larger than the first range.

As a specific example, it is assumed that the first book includes a first chapter to a tenth chapter. When the number of standby jobs is one to four, only the first chapter is set as the first partial book information. When the number of standby jobs is five to nineteen, the first chapter to the third chapter are set as the first partial book information. When the number of standby jobs is twenty or more, the first chapter to the fifth chapter are set as the first partial book information. When the number of standby jobs is zero, all the chapters may be set as the first partial book information.

According to the processing explained above, the following action effects can be obtained. When the number of standby jobs increases, a waiting time of the user also increases. However, since the determination unit 14 expands the second range to be larger than the first range, a printing range that can be viewed by the user increases when the waiting time of the user increases. The convenience for the user can be improved.

Although the first partial book information is explained above, similarly, a range of the second partial book information may be changed according to the number of standby jobs.

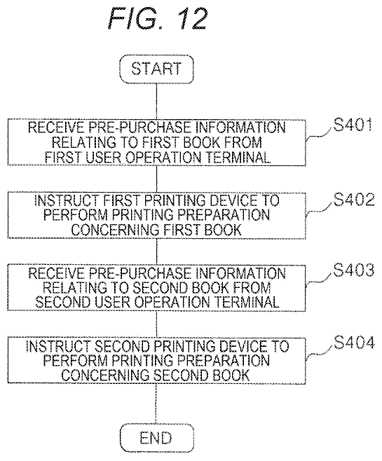

Next, another example in which the plurality of printing devices 21 are installed is explained with reference to FIG. 12. Here, similarly, one of the plurality of printing devices 21 is set as the first printing device 21A and another one is set as the second printing device 21B.

Based on reception of pre-purchase information relating to a first book selected in the first user operation terminal 22A (step S401), the determination unit 14 determines to perform printing preparation in the first printing device 21A for the first book and instructs the first printing device 21A to perform the printing preparation (step S402). Based on reception of pre-purchase information relating to a second book selected in the second user operation terminal 22B (step S403), the determination unit 14 determines to perform printing preparation in the second printing device 21B for the second book and instructs the second printing device 21B to perform the printing preparation (step S404).

According to the processing explained above, when a plurality of users are selecting books, it is possible to improve the convenience for the plurality of users by performing printing preparation for the respective users in separate printing devices.

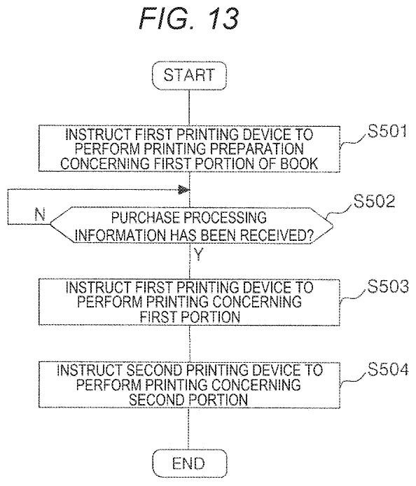

Another example in which the plurality of printing devices 21 are installed is explained with reference to FIG. 13. Here, similarly, one of the plurality of printing devices 21 is set as the first printing device 21A and another one is set as the second printing device 21B.

The determination unit 14 determines to perform printing preparation concerning a first portion, which is a part of a book, in the first printing device 21A and instructs the first printing device 21A to perform the printing preparation (step S501). Further, when the receiving unit 13 receives purchase processing information (Yes in step S502), the determination unit 14 determines to perform printing in the first printing device 21A for the first portion and instructs the first printing device 21A to perform printing (step S503) and determines to perform printing in the second printing device 21B for a second portion, which is a part of the book and is other than the first portion, and instructs the second printing device 21B to perform printing (step S504).

That is, in this example, one book is divided and different portions are printed in a plurality of printing devices. According to the processing explained above, it is possible to reduce a printing time in printing the one book. In the embodiment explained above, an example is explained in which one book is divided into two portions and different portions are printed in two printing devices. However, if there are three or more printing devices, the one book may be divided into three or more portions and different portions may be printed in the printing devices.

Concerning the printing preparation (step S130 in FIG. 9), only the first printing device 21A may be instructed and printing may be executed using the second printing device 21B if there is no standby job in the second printing device 21B when printing execution is actually instructed. Alternatively, the printing preparation may be instructed to both of the first printing device 21A and the second printing device 21B from the beginning.

When the number of the user operation terminals 22 that have transmitted the pre-purchase information is smaller than the number of the printing devices 21 to which the instruction unit 16 can instruct processing relating to the printing of the book, the determination unit 14 may determine to perform the printing in the first printing device 21A for the first portion and determine to perform the printing in the second printing device 21B for the second portion.

According to the processing explained above, it is possible to reduce a printing time in printing the one book.

When the number of the user operation terminals 22 that have transmitted the pre-purchase information is larger than the number of the printing devices 21 to which the instruction unit 16 can instruct the processing relating to the printing of the book, the determination unit 14 may determine to, in order of reception of the purchase processing information by the receiving unit 13, perform the printing using the printing device 21 having a smallest number of standby jobs for which the printing has not been completed.

According to the processing explained above, it is possible to suppress a waiting time of the user to the maximum.

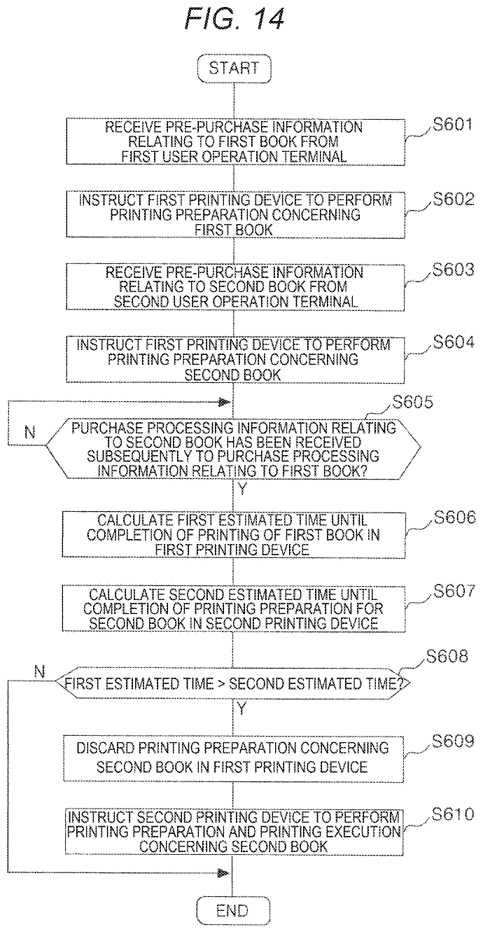

Further, another example in which the plurality of printing devices 21 are installed is explained with reference to FIG. 14. Here, similarly, one of the plurality of printing devices 21 is set as the first printing device 21A and another one is set as the second printing device 21B.

When the receiving unit 13 receives pre-purchase information concerning a first book selected in the first user operation terminal 22A (step S601), the determination unit 14 determines to perform printing preparation concerning the first book in the first printing device 21A and instructs the first printing device 21A to perform the printing preparation (step S602). When the receiving unit 13 receives the pre-purchase information concerning the second book selected in the second user operation terminal 22B (step S603), the determination unit 14 determines that the first printing device 21A performs the printing preparation concerning the second book, and instructs the first printing device 21A to perform the printing preparation (step S604).

Subsequently, when the receiving unit 13 receives purchase processing information relating to the second book after receiving the purchase processing information relating to the first book (Yes in step S605), the determination unit 14 calculates a first estimated time until the printing of the first book is completed in the first printing device 21A (step S606). Subsequently, the determination unit 14 calculates a second estimated time in the case in which printing preparation relating to the second book is performed in the second printing device 21B (step S 607). When the first estimated time is longer than the second estimated time (Yes in step S608), the determination unit 14 discards the printing preparation in the first printing device 21A concerning the second book, determines to perform the printing preparation and printing execution concerning the second book in the second printing device 21B, and instructs the second printing device 21B to perform the printing preparation and the printing execution (step S610).

According to the processing explained above, it is possible to effectively suppress a waiting time of the user by efficiently using the plurality of printing devices 21.

Another example in printing a book is explained.

The determination unit 14 may be capable of executing a mode for setting, as a target of printing preparation and printing by the printing device 21, a combined book formed by combining a part of a first book and a part of a second book different from the first book. Here, the “first book” and the “second book” describe a relationship between two books in the case of combining a plurality of books and are not limited to a case of combining two books. It goes without saying that three or more books can be combined.

For example, in the UI 30A illustrated in FIG. 7, a “set a part of this book as a part of a combined book” button (not illustrated) is provided and, by tapping the button, the UI 30A transitions to a selection UI (not illustrated) and a part of the book can be selected in the selection UI. A part of the book can be selected, for example, for any page or by chapter of a certain book.

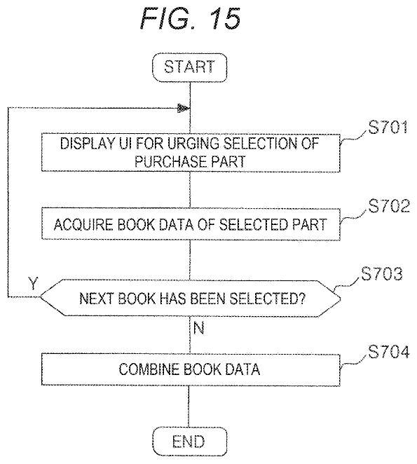

FIG. 15 is a flow of processing after the transition to the selection UI. The determination unit 14 displays a UI for urging selection of a purchase part (step S701) and, when the user selects the purchase part, acquires book data of the selected part (step S702). When the user selects the next book (Yes in step S703), the processing returns to step S701. When the user completes selection of all books (No in step S703), the determination unit 14 combines book data (step S704). Execution of the processing explained above may be started before purchase operation by the user is completed.

According to the processing explained above, the convenience for the user is improved.

When the processing explained above is performed, the book price is calculated by the determination unit 14 totaling prices of the selected parts.

Next, an example in which a machine learning model is used is explained.

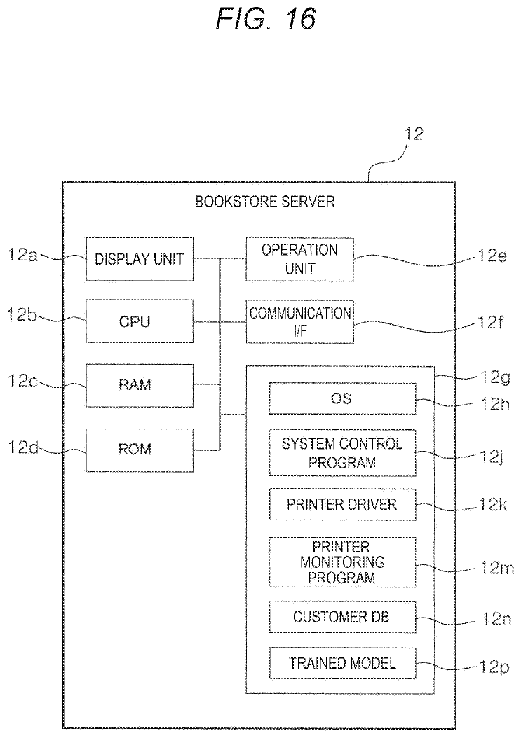

The bookstore server 12 illustrated in FIG. 16 is different from the bookstore server 12 in the embodiment explained above in that the storage 12g includes a trained model 12p. The trained model 12p is formed by combining a program and learned parameters.

As explained above, in the UI 30A illustrated in FIG. 7, the “proceed to purchase” button 30d being tapped, the “add to favorites” button 30e being tapped, the “preview” button 30g being tapped, the preview time being long, and the speed of page turning at the time of preview being low are considered to be user actions having a high likelihood of purchasing the book. Therefore, when a trained model obtained by performing machine learning using labeled training data in which the user actions explained above are input information and whether the book is actually purchased by the user is output information, it is possible to highly accurately estimate a probability that the user purchases the book.

As the input information, all of the user actions explained above may be adopted or any one or any plurality of the user actions explained above may be adopted. In particular, the preview time of the book is an example of a viewing time of information relating to the book. The user tends to purchase the book when the viewing time is long.

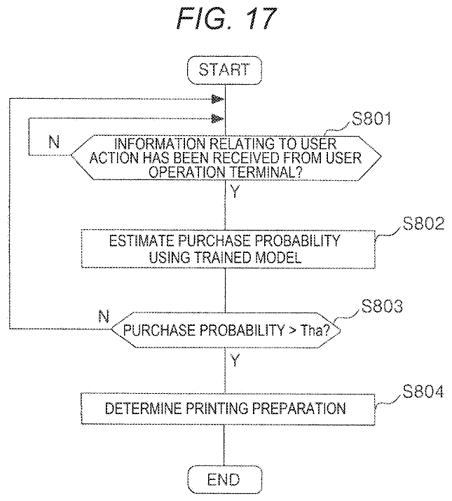

FIG. 17 is an example of processing performed by using the trained model 12p. When receiving information relating to a user action from the user operation terminal 22 (step S801), the determination unit 14 (see FIG. 1) of the bookstore server 12 estimates, using the trained model 12p, a probability that the user purchases a book (step S802). When the bookstore server 12 executes the trained model 12p, an estimation unit that estimates a probability that the user purchases a book is implemented in the bookstore server 12.

Here, the user operation terminal 22 transmits information relating to the user action to the bookstore server 12 in every predetermined time after the login operation by the user (step S101 in FIG. 5). As the predetermined time, an appropriate time such as ten seconds to sixty seconds can be set. The transmission of the information relating to the user action from the user operation terminal 22 to the bookstore server 12 may be performed only when a new user action occurs.

When the probability estimated by the estimation unit exceeds a predetermined value Tha, the determination unit 14 of the bookstore server 12 determines printing preparation (step S804). The determination of the printing preparation is equivalent to step S122 in FIG. 5.

By estimating, using the trained model 12p, the probability that the user purchases the book and performing the printing preparation based on a result of the estimation as explained above, the printing preparation is not wasted and it is possible to improve the convenience for the user.

As an algorithm of machine learning, for example, a logistic regression analysis, a decision tree, a deep neural network, a convolutional neural network, a recurrent neural network, and the like can be used.

The trained model 12p is generated in advance based on a predetermined number of labeled training data but may be additionally learned based on information received from the user operation terminal 22, that is, information relating to the user action explained above.

In the example explained above, the bookstore server 12 determines the printing preparation when the estimated probability exceeds the predetermined value Tha. However, the bookstore server 12 may instruct, based on the probability, the printing device 21 to execute printing. For example, the bookstore server 12 may determine, based on the probability, content to be executed, for example, when the probability is 50% to 80%, execute only the printing preparation and, when the probability exceeds 80%, instruct the printing device 21 to execute printing. Therefore, after determining the printing preparation in step S804, the bookstore server 12 may return to step S801 and continue to execute steps S801 and S802.

When it can be determined that the user has not purchased the book after the printing device 21 started executing the printing, the bookstore server 12 may determine to stop the printing and may instruct the printing device 21 to that effect. For example, the predetermined condition of step S202 illustrated in FIG. 10 may be adopted to determine that the user has not purchased the book.

In this case, an already generated print may be a stock of the work-in-process. In this case, the bookstore server 12 suitably generates and holds stock data including book information and printed page information. Thereafter, when executing printing because a probability that another user purchases the same book increases, the bookstore server 12 may refer to the stock data and instruct the printing device 21 to print the remaining pages. In this way, the printing of the book can be completed. According to the processing explained above, the print is not wasted and the user who has determined to purchase the book later can more quickly obtain the book.

The present disclosure is not limited to the embodiment and the modifications explained above and various modifications can be made within the scope of the disclosure set forth in the appended claims, and it is needless to say that these modifications also fall within the scope of the disclosure.

What is claimed is:

1. A printing management device comprising:
a receiving unit configured to receive, from an external terminal operated by a user, information relating to a book to be purchased;
a determination unit configured to determine, based on the information received by the receiving unit, processing that should be executed; and
an instruction unit configured to instruct, based on the determination of the determination unit, a printing device to perform processing relating to printing of the book, wherein
the receiving unit is configured to receive pre-purchase information including information for specifying the book selected by the user via the external terminal and purchase processing information including information relating to purchase processing for the book by the user, and
the determination unit determines execution of printing preparation for the book based on the reception of the pre-purchase information and determines, based on the reception of the purchase processing information, to print the book.

2. The printing management device according to claim 1, wherein the printing preparation includes generation of print data.

3. The printing management device according to claim 1, wherein the printing preparation includes a preparation operation in the printing device.

4. The printing management device according to claim 1, wherein
the pre-purchase information includes information concerning content of the book being previewed in the external terminal, and
the determination unit determines execution of the printing preparation for the book when the content of the book is previewed in the external terminal.

5. The printing management device according to claim 1, wherein the determination unit determines to stop the printing preparation when a predetermined condition is satisfied after determining to execute the printing preparation.

6. The printing management device according to claim 5, wherein the predetermined condition includes information received from the external terminal and relating to an action of the user on the external terminal.

7. The printing management device according to claim 5, wherein the predetermined condition includes information relating to execution status of the printing preparation.

8. The printing management device according to claim 1, wherein
the printing preparation includes generation of print data,
when the external terminal is set as a first external terminal, the receiving unit is configured to receive the pre-purchase information from a second external terminal different from the first external terminal, and
the determination unit determines, based on reception of the pre-purchase information relating to a first book selected in the first external terminal, to execute the printing preparation for first partial book information, which is a part obtained by dividing information relating to the first book, and determines, based on reception of the pre-purchase information relating to a second book selected in the second external terminal, to execute the printing preparation for second partial book information, which is a part obtained by dividing information relating to the second book.

9. The printing management device according to claim 8, wherein, when the receiving unit receives the purchase processing information for the second book subsequently to the purchase processing information for the first book, the determination unit determines to perform printing that is based on the second partial book information subsequently to printing that is based on the first partial book information.

10. The printing management device according to claim 9, wherein, when a range of the first partial book information in a case in which a number of standby jobs for which printing by the printing device is not completed is a first number is set as a first range and a range of the first partial book information in a case in which the number of standby jobs is a second number larger than the first number is set as a second range, the determination unit expands the second range to be larger than the first range.

11. The printing management device according to claim 8, wherein, when the printing device is set as a first printing device and the printing device different from the first printing device is set as a second printing device, the determination unit determines to perform the printing preparation concerning the first partial book information in the first printing device and determines to perform the printing preparation concerning the second partial book information in the second printing device.

12. The printing management device according to claim 1, wherein
when the external terminal is set as a first external terminal, the receiving unit is configured to receive the pre-purchase information from a second external terminal different from the first external terminal,
when the printing device is set as a first printing device, the instruction unit is configured to instruct a second printing device different from the first printing device to perform the processing relating to the printing of the book, and
the determination unit determines, based on reception of the pre-purchase information relating to a first book selected in the first external terminal, to perform the printing preparation for the first book in the first printing device and determines, based on reception of the pre-purchase information relating to a second book selected in the second external terminal, to perform the printing preparation for the second book in the second printing device.

13. The printing management device according to claim 1, wherein
when the printing device is set as a first printing device, the instruction unit is configured to instruct a second printing device different from the first printing device to perform the processing relating to the printing of the book,
the determination unit determines to perform the printing preparation concerning a first portion, which is a part of the book, in the first printing device, and
when the receiving unit receives the purchase processing information, the determination unit further determines to perform printing in the first printing device for the first portion and determines to perform printing in the second printing device for a second portion, which is a part of the book and is other than the first portion.

14. The printing management device according to claim 13, wherein, when a number of the external terminals that transmitted the pre-purchase information is smaller than a number of the printing devices that the instruction unit is configured to instruct to perform the processing relating to the printing of the book, the determination unit determines to perform the printing in the first printing device for the first portion and determines to perform the printing in the second printing device for the second portion.

15. The printing management device according to claim 1, wherein the determination unit executes a mode for setting, as a target of the printing preparation and the printing by the printing device, a combined book formed by combining a part of a first book serving as the book and a part of a second book different from the first book.

16. The printing management device according to claim 1, wherein, when a number of the external terminals that transmitted the pre-purchase information is larger than a number of the printing devices that the instruction unit is configured to instruct to perform the processing relating to the printing of the book, the determination unit determines to, in order of reception of the purchase processing information by the receiving unit, perform the printing using the printing device having a smallest number of standby jobs for which the printing is not completed.

17. The printing management device according to claim 1, wherein
when the external terminal is set as a first external terminal, the receiving unit is configured to receive is configured to receive the pre-purchase information from a second external terminal different from the first external terminal,
when the printing device is set as a first printing device, the instruction unit is configured to receive a second printing device different from the first printing device to perform the processing relating to the printing of the book, and
when the determination unit determines to perform, in the first printing device, the printing preparation concerning a first book selected in the first external terminal and the printing preparation concerning a second book selected in the second external terminal and the receiving unit receives the purchase processing information relating to the second book after the reception of the purchase processing information relating to the first book, the determination unit compares a first estimated time until completion of printing of the first book in the first printing device and a second estimated time in a case in which the printing preparation relating to the second book is performed in the second printing device and, when the first estimated time is longer than the second estimated time, discards the printing preparation concerning the second book in the first printing device and determines to perform the printing preparation and the printing concerning the second book in the second printing device.

18. A printing system comprising:
the printing management device according to claim 1; and
the printing device.

19. A printing system comprising:
the printing management device according to claim 1; and
the external terminal.

20. A printing system comprising:
the printing management device according to claim 1;
the external terminal; and
the printing device.
